(19) United States
(12) Patent Application Publication
(10) Pub. No.: US 2025/0189029 A1
(43) Pub. Date: Jun. 12, 2025

(54) DRIVE DEVICE FOR A VEHICLE AXLE

(71) Applicant: AUDI AG, Ingolstadt (DE)

(72) Inventors: Andreas WEBER, Ingolstadt (DE); Harald GLOEDE, Pförring (DE); Frank RÖTHLINGSHÖFER, Ingolstadt (DE); Korbinian WEBER, Ingolstadt (DE); Christian HOLZAPFEL, Lenting (DE)

(73) Assignee: AUDI AG, Ingolstadt (DE)

(21) Appl. No.: 18/846,339

(22) PCT Filed: Mar. 14, 2023
(86) PCT No.: PCT/EP2023/056406

§ 371 Date: Sep. 12, 2024

(30) Foreign Application Priority Data
Mar. 17, 2022 (DE) 10 2022 106 305.4

(51) Int. Cl. F16H 57/021; B60K 1/00; F16H 57/02; F16H 57/025; F16H 57/031; F16H 57/04

(52) U.S. Cl. CPC F16H 57/021; B60K 1/00; F16H 57/025; F16H 57/031; F16H 57/0404; F16H 57/0415; F16H 57/0436; F16H 57/045; F16H 57/0476; B60K 2001/001; B60K 2001/006; F16H 2057/02026; F16H 2057/02034; F16H 2057/02052

(57) ABSTRACT

A drive device for an electrified vehicle axle of a vehicle, including an electric machine, which acts via a transmission on flange shafts which are guided to vehicle wheels, and a cooling/lubrication module, which provides the electric machine and/or the transmission with coolant/lubricant. The drive device has a modular housing design in which a module housing of the cooling/lubricating module, a stator housing of the electric machine and a transmission housing are joined together as separate cast metal parts, in particular diecast parts, to form a unit.

### FIELD

The invention relates to a drive device for an electrified vehicle axle of a two-track vehicle.

### BACKGROUND

An electrically operated vehicle axle for a two-track motor vehicle has an electric machine which acts, via a transmission on flange shafts, each of which leads to a vehicle wheel. The electric machine and the transmission are part of a drive device that is supported via a three-point bearing or a four-point bearing, for example on a subframe of the vehicle body.

The conventional drive device has a bulky housing design, the housing parts of which are only partially die-cast due to their complex component geometry.

From DE 10 2019 112 677 A1 a hydraulic supply system for a vehicle is known. From DE 10 2019 205 758 A1 a transmission arrangement for a motor vehicle is known. From DE 10 2019 218 982 A1 a drive device for a hybrid vehicle is known.

### SUMMARY

The object of the invention is to provide a drive device for an electrified vehicle axle of a two-track vehicle, the housing design of which is more compact and easier to manufacture compared to the prior art.

The invention is based on a drive device having an electric machine, which acts on flange shafts connected to vehicle wheels via a transmission. The drive device also has a lubricating and/or cooling module that provides the electric machine and/or the transmission with coolant/lubricant. In accordance with the characteristic part of claim 1, the drive device has a modular, three-part housing design in which a module housing, a stator housing of the electric machine and a transmission housing are joined together as separate cast metal parts, in particular diecast parts, to form a drive unit. The housing parts of the drive unit are all designed with a component geometry that can be cast. In addition, the housing components, i.e. the stator housing, the transmission housing and the module housing are combined to form a much more compact unit compared to the state of the art.

In a technical implementation, the stator housing can be flanged on the transmission housing via a flange connection. The stator housing and the transmission housing can span an internal corner area in which the module housing of the cooling and/or lubricant module can be positioned conveniently. In the assembly state, the stator housing and the flange shafts are spaced around an axial distance to each other. With regard to a compact design of the aggregate, it is preferable that the module housing has a shaft delivery through which one of the flange shafts extends. In this case, the oil tank in the module housing may be formed as a ring space extending around the flange shaft.

The transmission housing can be constructed from two parts of the housing, which can be arranged in an axial succession, for easy assembly/disassembly. In this case, the transmission housing has an intermediate housing and a housing cover. Both the stator and module housings can be flanged on one side of the intermediate housing. On the other hand, the cover can be flanged to the axially facing side of the intermediate housing and close the transmission housing interior.

In the assembly state, the stator housing and the module housing are horizontally spaced. In order to avoid component vibration during operation, it is preferable that the stator housing and the module housing, especially on their transmission-far side, are connected to each other by force transfer via a support part.

In a concrete design variant, the electric machine can be installed in the vehicle's axle in the transverse installation. In this case, the stator housing of the electric machine in the vehicle's transverse direction may be axially extended with the transmission housing. The drive unit can also be supported in a three-point bearing via a total of three unit bearings in the vehicle body.

According to the invention the module housing is located immediately next to the stator housing. The oil volume for dry sump lubrication is included in the module housing. At the same time, oil pipelines and components connected to the oil circuit are included here, namely oil-water heat exchangers/oil filters/oil pump. With the invention, a housing construction is achievable, which has a low construction height compared to the state of the art and allows a high efficiency (i.e. reduction of Pantsch losses to rotating parts).

Due to the position of the power electronics on the top of the aggregates, all the aggregate bearings can be positioned sideways on the intermediate housing, on the transmission cover and on the stator housing. In addition, a power electronics arrangement on the top of the aggregates does not produce any force discharges on the sensitive parts within the power electronics (i.e., pulse inverters). The resulting drive unit can be tested and mounted as a module. Due to its compact design, the drive unit is suitable for mounting in the front axle as well as for mounting in the rear axle. In addition, the force infeed of the reaction forces from the drive is carried out directly from the motor supports into the housing, thereby eliminating screw planes, and with a low lever arm (thus, stiffening ribs can be dimensioned considerably less). The stator housing can be manufactured in a higher-elongation Al alloy compared to the transmission housing and the module housing. As a result, it is no longer necessary for expensive alloys to be used in areas that do not require higher elongation due to the concept.

Due to the compact design of the drive unit, the box size relevant for the package is small and is well exploited. Therefore, hardly any converted space remains, which is not used. The use of the support part between the stator housing and the module housing leads to an acoustic improvement in the running mode. The torque conversion taking place in the transmission and the resulting bearing support forces would result in a vibration without support part assembly. This can be reduced very effectively by the support part acting as a thrust field in the high direction as well as in the transverse direction, which greatly improves the acoustics. At the same time, assembly in the vehicle longitudinal direction is not hindered and the length tolerance can be very well balanced.

The compact design of the invention results in a package geometry that is roughly shaped like cubes. In addition, the modular design has advantages in the sequencing of the assembly: In this way, sub-assemblies can be pre-assembled in parallel before they are assembled into the drive unit. Accessibility is also ensured during assembly. In addition, a test of subunits can be carried out before the assembly of the drive unit and thus a guarantee of quality can be made. Furthermore, the engineered housing construction offers a high degree of integration into individual components (oil module, intermediate housing). In this way, oil pipelines for pressure/suction oil can be integrated. The individual housings can also be designed to fit the mold. With the housing design according to the invention, a high stiffness is also obtained, since a thrust field can be formed in the transmission housing and intermediate housing for the gear bearing at high loads.

For perfect operation, reliable moment support of reaction forces is important. For this purpose, the three-point bearing has two transmission-side unit bearings, via which the transmission housing is supported in the vehicle body. The two transmission-side unit bearings are arranged on opposite sides in the vehicle's longitudinal direction with respect to the flange shaft axis, thereby providing torque support in both directions of flange shaft rotation.

In a technical implementation, the housing cover and the intermediate housing can each have a bearing wall. The bearing walls of the housing cover and of the intermediate housing are axially opposite each other in the transverse direction of the vehicle. In addition, the bearing walls each have bearing points for the transmission shafts and for the flange shafts. To ensure stable rotary mounting of the transmission shafts and the flange shafts, the housing cover and the intermediate housing are designed with appropriate component rigidity. In order to achieve a reliable support of the drive unit, it is preferred if a first transmission-side unit bearing of the two transmission-side unit bearings is formed on the housing cover, while the second transmission-side unit bearing is formed on the intermediate housing. In contrast to the two unit bearings on the transmission side, a third unit bearing is formed directly on the stator housing in order to reliably support its component weight.

To ensure perfect rotary support of the transmission shafts and the flange shafts, the bearing walls of the housing cover and the intermediate housing are designed to be rigid using appropriate material. In a preferred embodiment, the first transmission-side unit bearing can be located in a bearing wall plane of the housing cover, while the second transmission-side unit bearing can be located in a bearing wall plane of the intermediate housing. In this way, the bearing walls of the housing cover and the intermediate housing have a double function of shearing plates in which reaction forces can be introduced without deformation during driving, thus achieving extremely rigid torque support for the component.

As a result of the design of the two unit bearings directly on the transmission housing, there is a comparatively small transverse offset (lever arm length) relative to the axle differential when viewed in the transverse direction of the vehicle, which means that, for example, deflections or twisting of the drive unit due to introduced reaction forces can be easily prevented by design.

In a structurally simple embodiment variant, each of the unit bearings can be designed as a rubber-metal sleeve bearing that is pressed into a mounting eye of the transmission housing and/or the stator housing. The mounting eye can be made of the same material and formed as a single piece on the transmission housing or the stator housing. In order to achieve particularly effective torque support, it is preferred if the position axes of the two transmission-side unit bearings and, in particular, of the stator housing-side unit bearing are aligned with their axes parallel to the flange shaft axis.

### BRIEF DESCRIPTION OF THE FIGURES

An exemplary embodiment of the invention is described below by means of the appended figures.

In particular:

FIG. 1 is a block diagram of a drive device for an electrified vehicle axle of a vehicle;

FIG. 2 shows the drive unit in a sectional representation;

FIG. 3 is a schematic view the housing structure of the drive unit.

### DETAILED DESCRIPTION

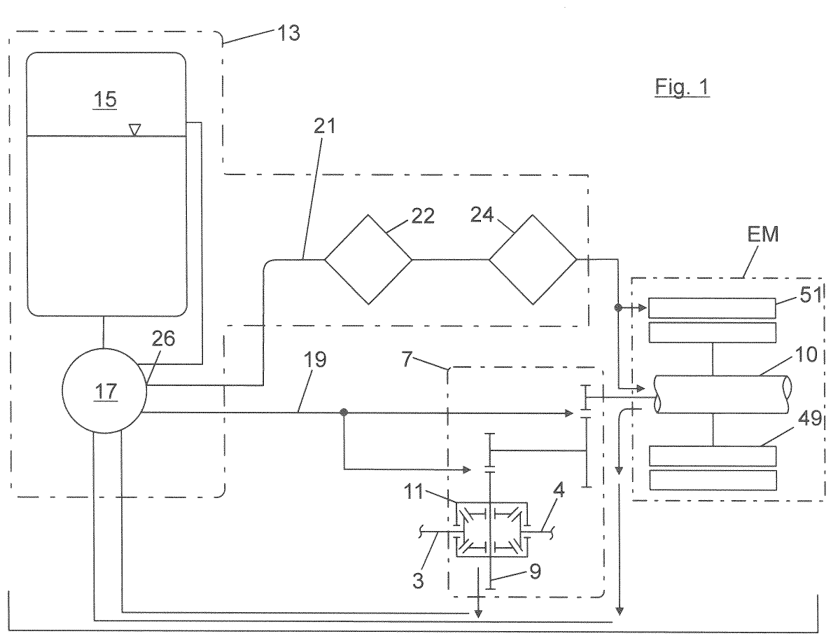

FIG. 1 shows a simplified block circuit diagram of a drive device for a vehicle axle of a two-track vehicle. The drive device has an electric machine which, when installed transversely, is arranged axially parallel to the flange shafts 3 guided to the vehicle wheels. The rotor shaft 10 of the electric machine EM is connected to the two flange shafts 3, 4 via a transmission 7. In FIG. 1, the transmission 7 has a double spur gear train, which is connected to an input gear 9 of an axle differential of 11. The axle differential 11 drives off on both sides to the flange shafts 3, 4 led to the vehicle wheels.

In addition, the drive device has an oil module 13, the structure of which is described below only to the extent necessary for the understanding of the invention. Consequently, oil module 13 has an oil tank 15, which is connected to a multi-stage pump 17 via a suction line. From the multi-stage pump 17, an electric power line 21 leads to the EM electric machine to supply it with oil. From the EM electric machine, oil is sucked through a return pipe towards the multi-stage pump 17. A heat exchanger 22 and an oil filter 24 is arranged in the electric power supply line 21, which are also components of the oil module 13.

In addition, a transmission supply line 19 from the multi-stage pump 17 leads to the transmission 7. Oil is fed through the transmission supply line 19 to transmission 7 tooth contact points. The oil drips from the tooth intervention points, collects in an oil sump and is sucked from there via another return pipe towards multi-stage pump 17.

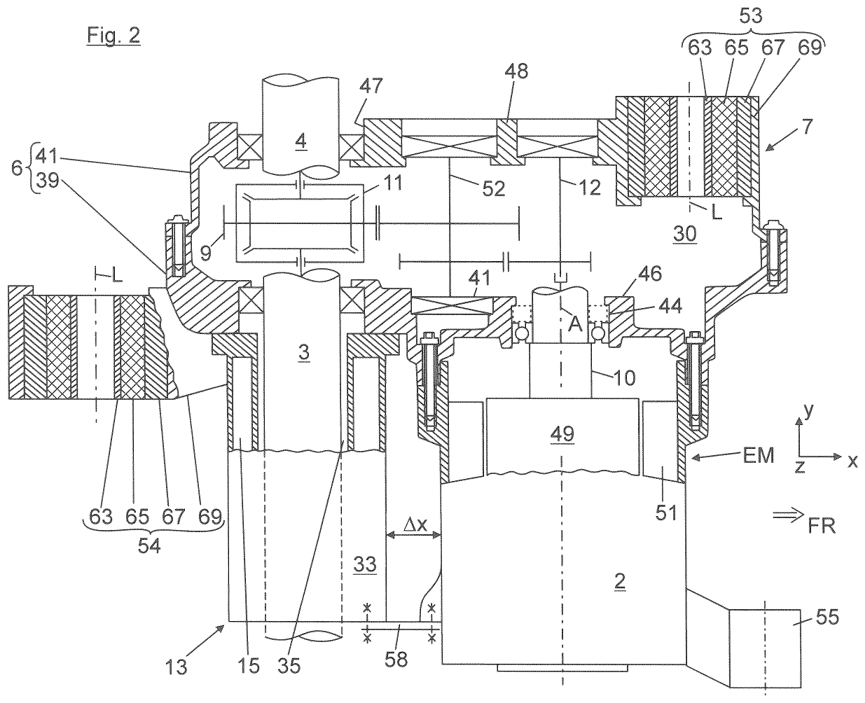

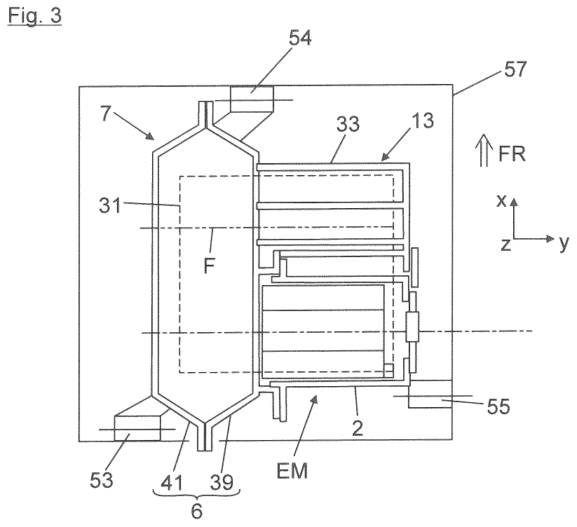

In FIG. 2 or 3, the EM electric machine, transmission 7 and oil module 13 are assembled into a drive unit. In the drive unit, the EM electric machine and the oil module 13 are positioned parallel to the axis and spaced to each other via an axial difference x (FIG. 2). The electric machine EM has a cylindrical stator housing 2 which is axially extended in the vehicle transverse direction y by a transmission housing 6. In addition, the stator housing 2 of the EM electric machine and the module housing 33 of the oil module 13 are flanged via flange connections on the transmission 7. The housing structure of the drive unit is shown sketchy in a view from above in FIG. 3. According to this, the electric machine 1 is assigned a power electronics (indicated with a dashed line) 31. This is located on the top of the drive unit.

The oil module 13 has a modular housing 33 in FIG. 2 or 3. The module housing 33 is, as well as the transmission housing 6 and the stator housing 2, as a cast part. The multi-stage pump 17, the heat exchanger 22 and the oil filter 24 are mounted on the module housing 33. The oil tank 15 is integrated in the module housing 33 as a ring space shown in FIG. 2 (FIG. 2), which limits a shaft delivery 35 in module housing 33. The shaft 35 leads the flange shaft 3 from the transmission 7 to one of the vehicle wheels.

As further shown in FIG. 2, the stator housing 2 and the module housing 33 are connected to each other by force transfer on their transmission-far side via a support part 58, by which component vibrations can be reduced

According to FIG. 2 or 3, the transmission housing 6 is constructed in two parts with an intermediate housing 39 and a housing cover 41. The intermediate housing 39 is positioned in the axial direction between the module housing 33 and the housing cover 41.

Both the spur gear stage and the axle differential 11 are arranged in the transmission housing 6. The housing cover 41 closes the transmission interior 30 in the axial direction (FIG. 2). In FIG. 2, the transmission interior 30 is axially delimited in the vehicle transverse direction y by a bearing wall 46 of the intermediate housing 39 and by a bearing wall 48 of the housing cover 41. The bearing wall 46 of the intermediate housing 39 has a bearing opening 44 in which the rotor shaft 10 of the electric machine EM is rotatably mounted. In addition, the bearing wall 46 of the intermediate housing 39 has a shaft passage 35 in which the left flange shaft 3 is rotatably mounted. Furthermore, the bearing wall 46 of the intermediate housing 39 is formed with a pivot bearing point for the intermediate transmission shaft 52. The bearing wall 48 of the housing cover 41 has two bearing openings for the transmission input shaft 12 and for the intermediate transmission shaft 52 as well as a shaft passage 47 in which the right flange shaft 4 is rotatably mounted.

FIG. 3 shows an installation position of the drive unit. Accordingly, the drive unit is supported in a three-point bearing with a total of three unit bearings 53, 54, 55 on a roughly schematically indicated subframe 57. In FIG. 3, the subframe 57 has two lateral subframe longitudinal members, which are each connected to subframe cross members at the front and rear of the vehicle.

This has two transmission-side unit bearings 53, 54, via which the transmission housing 6 is supported on the subframe 57. The two transmission-side unit bearings 53, 54 are arranged on opposite sides, i.e. at the front and rear of the vehicle, with respect to the flange shaft axis F (FIG. 2) in the vehicle longitudinal direction x. By way of example, in FIG. 3 the first transmission-side unit bearing 53 is connected to the rear subframe cross member, while the second transmission-side unit bearing 54 is connected to the front subframe cross member. The third unit bearing 55, on the other hand, is arranged on the stator housing 2, which primarily supports the electric machine EM, in the region of which the center of gravity of the drive unit is located.

During vehicle operation, reaction forces are introduced from the vehicle wheels into the axle differential 11 via the flange shafts 3, 4 and from there to the rest of the drive unit 1. For a stable torque support of the reaction forces FR, the two transmission-side unit bearings 53, 54 are positioned with an extremely small transverse offset relative to the axle differential 11, when viewed in the vehicle transverse direction y.

The unit bearings 53, 54, 55 are each designed as rubber-metal sleeve bearings, as indicated in FIG. 2. Accordingly, each of the shown unit bearings 53, 54 has an inner, sleeve-shaped bearing core 63 which is connected to an outer sleeve 67 via an elastomer body 65. The radially inner bearing core 63 can be connected to bearing brackets of the subframe 57 via a bearing bolt (not shown). The bearing axes L of the two transmission-side unit bearings 53, 54 as well as of the stator housing-side assembly bearing 55 are each aligned in the vehicle transverse direction y as shown in FIGS. 2.

As can be seen from FIG. 3, the first transmission-side unit bearing 53 is formed on the housing cover 41. The first transmission-side unit bearing 53 lies together with the bearing wall 48 of the housing cover 41 in a common plane. In the case of loading, the bearing wall 48 therefore acts as a component-rigid shearing plate. The second transmission-side unit bearing 54 is formed analogously on the intermediate housing 39. The second transmission-side unit bearing 54 lies together with the bearing wall 46 of the intermediate housing 27 in a common plane, whereby the bearing wall 46 of the intermediate housing 39 also acts as a component-rigid shearing plate in the event of a load.

### LIST OF REFERENCE NUMERALS

2 stator housing
3, 4 flange shafts
5 rotor shaft
6 transmission housing
7 transmission
9 input gear
10 rotor shaft
11 axle differential
12 transmission input shaft
13 oil module
15 oil tank
17 multiple pump
19 transmission supply line
21 electric machine power line
26 pump outlet
30 transmission interior
31 power electronics
32 oil filter inlet
33 module housings
34 oil filter outlet
35 shaft passage
39 intermediate housing
41 housing cover
44 bearing opening
46 bearing wall of the intermediate housing 39
47 shaft passage
48 bearing wall of the transmission cover 41
49 rotor
EM electric machine
Δx axial distance
52 intermediate shaft
51 stator
53, 54, 55 unit bearing
57 subframe
58 support part
63 inner bearing core
65 elastomer body
67 outer sleeve
69 mounting eye
L bearing axes
F flange shaft axis

1-10. (canceled)

11. A drive device for an electrified vehicle axle of a vehicle, comprising: an electric machine, which operates on flange shafts which are connected to vehicle wheels via a transmission, and with a cooling/lubricating module which provides the electric machine (EM) and/or the transmission with a coolant/lubricant, wherein the drive device has a modular housing design in which a module housing of the cooling/lubricating module, a stator housing of the electric machine and a transmission housing are assembled into a unit as separate cast metal parts, in particular diecast parts.

12. The drive device according to claim wherein the stator housing is flanged over a flange connection to the transmission housing, and the stator housing and the transmission housing span an inner corner area in which the module housing is located, and/or in that the module housing has a shaft passage through which one of the flange shafts extends.

13. The drive device according to claim 11, wherein the transmission housing is composed of two parts of the housing arranged in an axial succession, consisting of an intermediate housing and a housing cover, and in that both the stator housing and the module housing are flanged on one side of the intermediate housing, and in that on the axially opposite intermediate housing the housing cover is flanged and closes the transmission housing interior.

14. The drive device according to claim 11, wherein the stator housing and the module housing are spaced by an axial distance, and in particular the stator housing and the module housing, in particular on the transmission-far side, are connected to each other by force transfer via a support part (58).

15. The drive device according to claim 11, wherein by the fact that the electric machine is mounted in the vehicle axle in the transverse installation and that the stator housing of the electric machine in the vehicle's transverse direction is axially extended with the transmission housing, and/or that the unit is supported in a three-point position by three aggregate bearings in the vehicle body.

16. The drive device according to claim 15, wherein the intermediate housing and the housing cover each have bearing walls which are axially opposite each other, and in particular in that in the bearing walls of the intermediate housing and of the housing cover, transmission shafts, and flange shafts are rotationally mounted.

17. The drive device according to claim 15, wherein the first transmission-side unit bearing is formed on the housing cover, in that the second transmission-side unit bearing (54) is formed on the intermediate housing and in that the third unit bearing is formed on the stator housing.

18. The drive device according to claim 11, wherein the power electronics of the electric machine, which cover at least part of the transmission housing, the module housing and the stator housing, are located at the top of the drive unit.

19. The drive device according to claim 11, wherein each of the unit bearings is designed as a rubber-metal sleeve bearing which is pressed into a mounting eye of the transmission housing and/or the stator housing and in that the mounting eyes of the unit bearings are formed in material connection on the stator housing, the intermediate housing and the housing cover.

20. The drive device according to claim 11, wherein on the module housing, a pump unit, a heat exchanger, an oil filter and/or an oil tank are formed or mounted, which are components of a hydraulic circuit for cooling/lubrication of the electric machine and transmission.

21. The drive device according to claim 12, wherein the transmission housing is composed of two parts of the housing arranged in an axial succession, consisting of an intermediate housing and a housing cover, and in that both the stator housing and the module housing are flanged on one side of the intermediate housing, and in that on the axially opposite intermediate housing the housing cover is flanged and closes the transmission housing interior.

22. The drive device according to claim 12, wherein the stator housing and the module housing are spaced by an axial distance, and in particular the stator housing and the module housing, in particular on the transmission-far side, are connected to each other by force transfer via a support part.

23. The drive device according to claim 13, wherein the stator housing and the module housing are spaced by an axial distance, and in particular the stator housing and the module housing, in particular on the transmission-far side, are connected to each other by force transfer via a support part.

24. The drive device according to claim 12, wherein by the fact that the electric machine is mounted in the vehicle axle in the transverse installation and that the stator housing of the electric machine in the vehicle's transverse direction is axially extended with the transmission housing, and/or that the unit is supported in a three-point position by three aggregate bearings in the vehicle body.

25. The drive device according to claim 13, wherein by the fact that the electric machine is mounted in the vehicle axle in the transverse installation and that the stator housing of the electric machine in the vehicle's transverse direction is axially extended with the transmission housing, and/or that the unit is supported in a three-point position by three aggregate bearings in the vehicle body.

26. The drive device according to claim 14, wherein by the fact that the electric machine is mounted in the vehicle axle in the transverse installation and that the stator housing of the electric machine in the vehicle's transverse direction is axially extended with the transmission housing, and/or that the unit is supported in a three-point position by three aggregate bearings in the vehicle body.

27. The drive device according to claim 16, wherein the first transmission-side unit bearing is formed on the housing cover, in that the second transmission-side unit bearing is formed on the intermediate housing and in that the third unit bearing is formed on the stator housing.

28. The drive device according to claim 12, wherein the power electronics of the electric machine, which cover at least part of the transmission housing, the module housing and the stator housing, are located at the top of the drive unit.

29. The drive device according to claim 13, wherein the power electronics of the electric machine, which cover at least part of the transmission housing, the module housing and the stator housing, are located at the top of the drive unit.

30. The drive device according to claim 14, wherein the power electronics of the electric machine, which cover at least part of the transmission housing, the module housing and the stator housing, are located at the top of the drive unit.
